(19) United States
(12) Patent Application Publication
(10) Pub. No.: US 2019/0050551 A1
(43) Pub. Date: Feb. 14, 2019

(54) SYSTEMS AND METHODS FOR AUTHENTICATING USERS

(71) Applicant: Facebook, Inc., Menlo Park, CA (US)

(72) Inventors: Ethan Goldman-Kirst, Seattle, WA (US); John Anderson, Woodinville, WA (US); Chanel Yih Shyuan Huang, Seattle, WA (US); Elaine Levey, Seattle, WA (US)

(21) Appl. No.: 15/673,077

(22) Filed: Aug. 9, 2017

(51) Int. Cl. G06F 21/33; H04L 29/06

(52) U.S. Cl. CPC G06F 21/335; H04L 63/0823; H04L 9/321; H04L 63/102; H04L 63/0884

(57) ABSTRACT

A computer-implemented method for authenticating users may include (i) identifying, on a computing system, an attempt by a user to access an application that requires authentication, (ii) sending, in response to identifying the attempt to access the application, a request for an authentication token for the application to a third-party platform for which the user has a pre-existing user account and to which the user is currently authenticated on the computing system, (iii) receiving the authentication token for the application from the third-party platform that is associated with the pre-existing user account for the user in response to sending the request for the authentication token, and (iv) authenticating the user to the application on the computing system via the authentication token associated with the pre-existing user account in response to receiving the authentication token. Various other methods, systems, and computer-readable media are also disclosed.

### BACKGROUND

When computers first became popular, an entire office or family might share a single device. Now many users have multiple computing devices in their homes, offices, and on their persons, including tablets, laptops, smart phones, and even smart watches. Each of these computing devices provides rich functionality including the ability to interact with a wide variety of applications and services over the Internet. Many applications are implemented on multiple platforms. Thus, a user may access a web-based instance of an application via a desktop web browser or a mobile instance of the application on a smart phone or tablet. While not all applications require authentication, many applications encourage the user to have an account in order to save user-specific information and/or to access additional application functionality. The potentially large number of user accounts for different applications and services may overwhelm and frustrate users, especially users who operate multiple devices and must authenticate to various versions of each application on different devices.

Some traditional systems for managing authentication to multiple accounts for different services store usernames, passwords, and other credential information. However, these systems may still require a user to create a different account for every service. Accordingly, the instant disclosure identifies and addresses a need for additional and improved systems and methods for authenticating users to various applications across different platforms.

### SUMMARY

As will be described in greater detail below, the instant disclosure describes various systems and methods for authenticating users to applications on various platforms by using an authentication token provided by an identity assertion provider to automatically authenticate a user to an application to which the user has previously authenticated.

In one example, a method for authenticating users may include (i) identifying, on a computing system, an attempt by a user to access an application that requires authentication, (ii) sending, in response to identifying the attempt to access the application, a request for an authentication token for the application to a third-party platform for which the user has a pre-existing user account and to which the user is currently authenticated on the computing system, (iii) receiving the authentication token for the application from the third-party platform that is associated with the pre-existing user account for the user in response to sending the request for the authentication token, and (iv) authenticating the user to the application on the computing system via the authentication token associated with the pre-existing user account in response to receiving the authentication token.

In some examples, authenticating the user to the application on the computing system may include notifying the user that the user has been authenticated to the application via the pre-existing user account. Additionally or alternatively, the computer-implemented method may include (i) identifying, on the computing system, the attempt by the user to access the application by determining that the user has the pre-existing user account for the third-party platform and providing the user with an option to authenticate to the application via the pre-existing user account in response to determining that the user has the pre-existing user account, (ii) determining that the user has chosen the option to authenticate to the application via the pre-existing user account, and (iii) sending the request for the authentication token for the application to the third-party platform is in response to determining that the user has chosen the option to authenticate to the application via the pre-existing user account.

In one embodiment, receiving the authentication token for the application from the third-party platform that is associated with the pre-existing user account may include receiving a set of permissions for the application associated with the user account and authenticating the user to the application on the computing system includes applying the set of permissions to the application. In one embodiment, identifying, on the computing system, the attempt by the user to access the application that requires authentication may include identifying that the user is attempting to access an authenticated portion of the application that is separate from an unauthenticated portion of the application.

In some embodiments, identifying, on the computing system, the attempt by the user to access the application that requires authentication may include determining that the application accepts the authentication token provided by the third-party platform as a form of authentication. In some examples, authenticating the user to the application on the computing system via the authentication token may include enabling the user to avoid authenticating to the application via an authentication step that requires user input.

In some embodiments, the computer-implemented method may further include determining that the user is currently authenticated to the third-party platform on the computing system. In these embodiments, sending the request for an authentication token for the application to the third-party platform for which the user has the pre-existing user account and to which the user is currently authenticated on the computing system may take place in response to determining that the user is currently authenticated to the third-party platform on the computing system.

In one embodiment, the computing system may include a mobile device. In one embodiment, the third-party platform may include a social media platform.

Additionally or alternatively, a computer-implemented method for authenticating users may include (i) identifying, by an identity assertion provider, a successful authentication by a user to a third-party application on a computing system via a user account of the user with the identity assertion provider, (ii) receiving, by the identity assertion provider, a request from an additional computing system that does not include the computing system for an authentication token to authenticate the user to an instance of the third-party application on the additional computing system, (iii) determining that the user has previously authenticated to the third-party application on the computing system that does not include the additional computing system via the user account with the identity assertion provider, and (iv) issuing an authentication token to the instance of the third-party application on the additional computing system for the user of the third-party application that is associated with the user account for the identity assertion provider in response to determining that the user has previously authenticated to the third-party application via the user account.

In one embodiment, the identity assertion provider may not store user credentials for the third-party application. In one embodiment, determining that the user has previously authenticated to the third-party application on the computing system may include determining that the user previously authenticated to the third-party application on the computing system via the authentication token and issuing the authentication token to the instance of the third-party application on the additional computing system may include issuing the same authentication token used for the third-party application on the computing system.

In one embodiment, determining that the user has previously authenticated to the third-party application on the computing system may include determining that the user has previously applied a set of permissions to the third-party application on the computing system. In this embodiment, issuing the authentication token to the instance of the third-party application on the additional computing system may include sending, to the additional computing system, the set of permissions for the third-party application that were previously applied by the user.

In one embodiment, the identity assertion provider may include a social networking platform. In some examples, the computer-implemented method may further include determining that the user is currently authenticated to the identity assertion provider via the additional computing system and issuing the authentication token is in response to determining that the user is currently authenticated to the identity assertion provider via the additional computing system.

In addition, a corresponding system for authenticating users may include several modules stored in memory, including (i) an authentication identification module, stored in memory of an identity assertion provider, that identifies a successful authentication by a user to an application on a first computing system via a user account of the user with the identity assertion provider, (ii) an application identification module, stored in memory of a second computing system, that identifies an attempt by the user to access the application that requires authentication, (iii) a sending module, stored in the memory of the second computing system, that sends, in response to identifying the attempt by the user to access the application, a request for an authentication token for the application to the identity assertion provider for which the user has the user account and to which the user is currently authenticated on the second computing system, (iv) a request receiving module, stored in the memory of the identity assertion provider, that receives the request from the second computing system that does not include the first computing system for the authentication token to authenticate the user to an instance of the application on the second computing system, (v) a determination module, stored in the memory of the identity assertion provider, that determines that the user has previously authenticated to the application on the first computing system that does not include the second computing system via the user account with the identity assertion provider, (vi) an issuing module, stored in the memory of the identity assertion provider, that issues, to the instance of the application on the second computing system, the authentication token for the user of the application that is associated with the user account for the identity assertion provider in response to determining that the user has previously authenticated to the application via the user account, (vii) a token receiving module, stored in the memory of the second computing system, that receives the authentication token for the application from the identity assertion provider that is associated with user account in response to sending the request for the authentication token, (viii) an authentication module, stored in the memory of the second computing system, that authenticates the user to the application on the second computing system via the authentication token associated with the user account in response to receiving the authentication token, and (ix) at least one physical processor configured to execute the authentication identification module, the application identification module, the sending module, the request receiving module, the determination module, the issuing module, the token receiving module, and the authentication module.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a flow diagram of an exemplary method for authenticating users.

FIG. 2 is a flow diagram of an exemplary method for authenticating users.

FIG. 3 is a block diagram of an exemplary notification.

FIG. 4 is a block diagram of an exemplary system for authenticating users.

FIG. 5 is a block diagram of an exemplary system for authenticating users.

FIG. 6 is a flow diagram of an exemplary method for authenticating users.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for authenticating users. As will be explained in greater detail below, embodiments of the instant disclosure may increase convenience, efficiency, and security for users authenticating to applications on different platforms. By using an authentication token from an identity assertion provider to authenticate a user to an application, the systems and methods described herein may enable a user to authenticate to an application without entering credentials or using a third-party credential storing service. Additionally, by using an authentication token associated with a user account on the identity assertion provider, the systems and methods described herein may enable users to safely authenticate to a wide variety of applications and/or services without creating an additional user account for each new service.

In addition, by automatically authenticating the user if the user has previously, on another computing device, authenticated to an instance of the application via their user account with the identity assertion provider (e.g., instead of prompting the user to enter login credentials for and/or create a user account), the systems and methods described herein may prevent forgetful or confused users from unnecessarily creating duplicate accounts for the same application. In addition, the systems and methods described herein may improve the functioning of a computing device by enabling users to access applications on the computing device more efficiently and securely. These systems and methods may also improve the field of authentication security by enabling users to authenticate to accounts while neither storing credentials for those accounts nor turning over the credentials to those accounts to a third party.

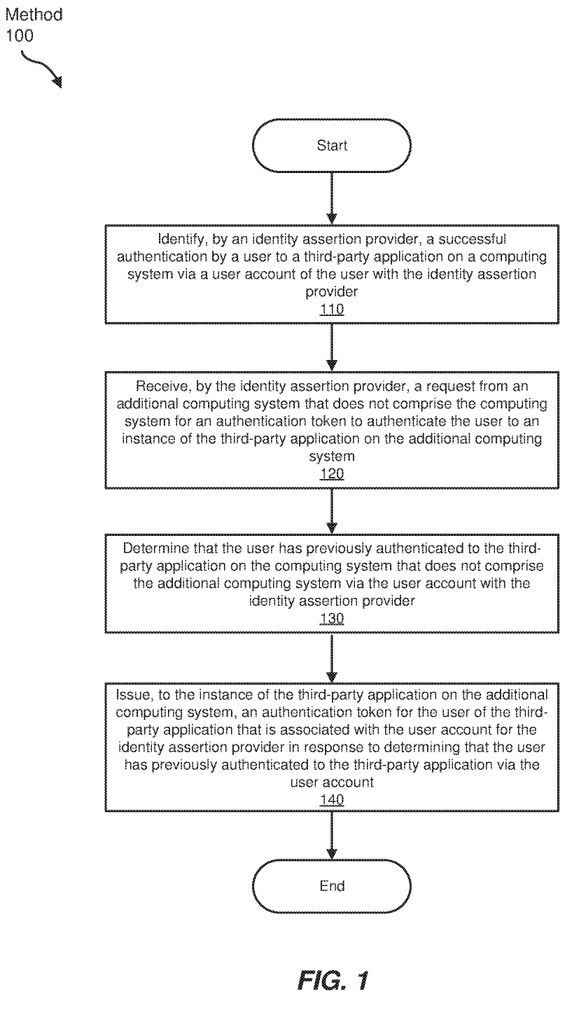

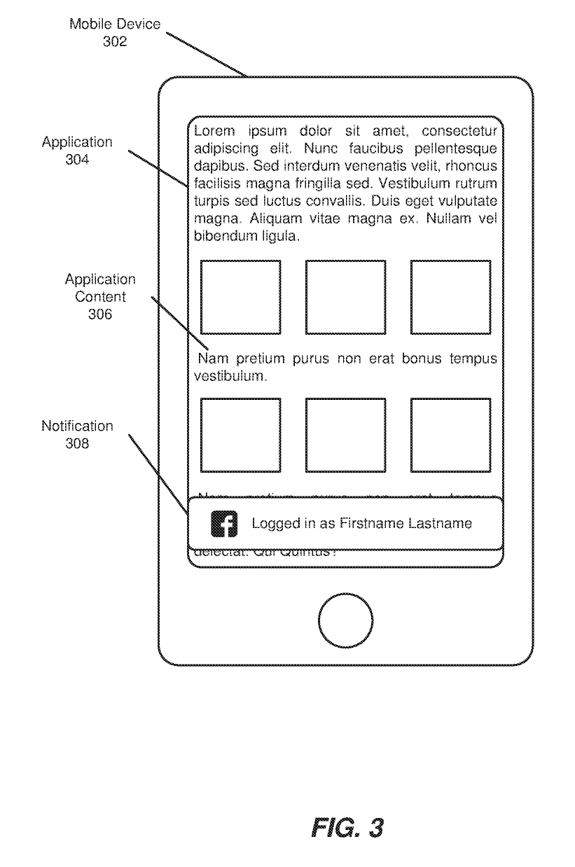

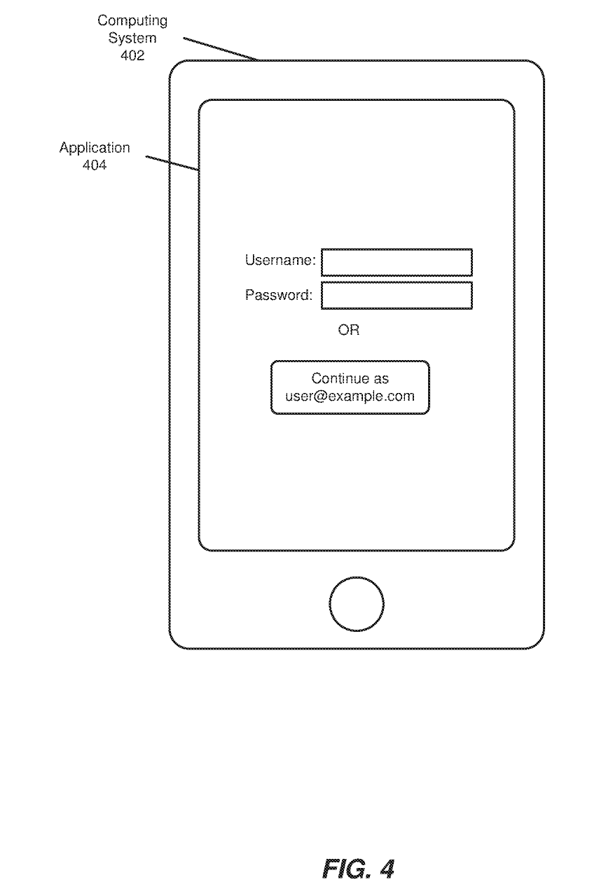

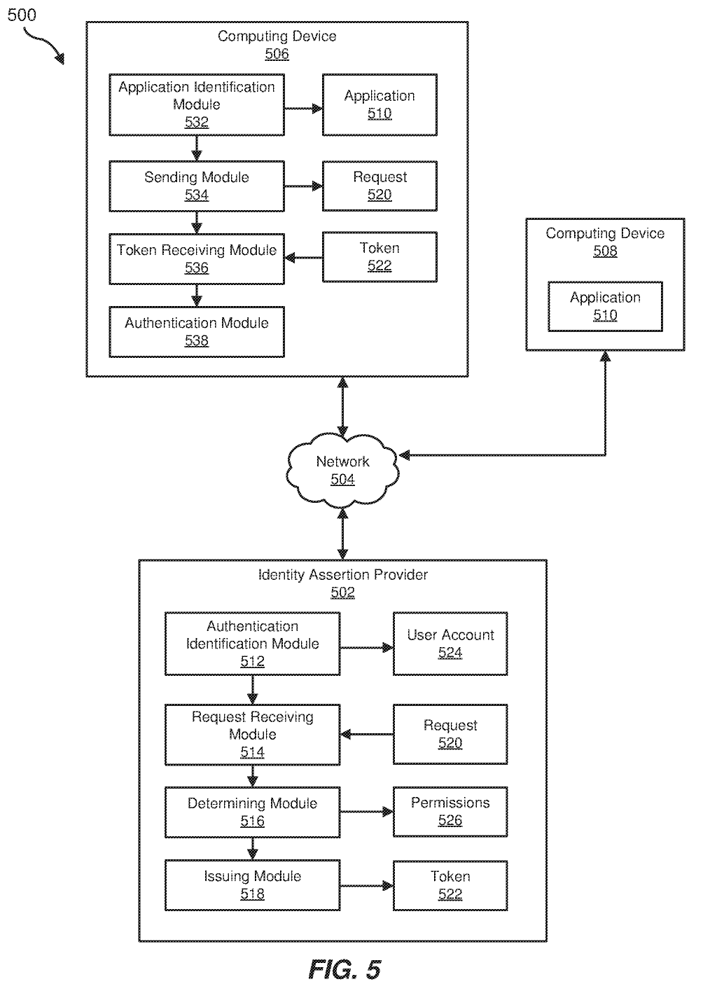

The following will provide, with reference to FIGS. 1, 2, and 6, detailed descriptions of exemplary methods for authenticating users. A detailed description of an exemplary notification will be provided in reference to FIG. 3. In addition, a detailed description of exemplary systems for authenticating users will be provided in reference with FIGS. 4 and 5.

FIG. 1 is a flow diagram of exemplary method 100 for authenticating users. As illustrated in FIG. 1, at step 110, one or more of the systems described herein may identify, by an identity assertion provider, a successful authentication by a user to a third-party application on a computing system via a user account of the user with the identity assertion provider.

The term “identity assertion provider,” as used herein, generally refers to any platform and/or service that provides tokens that users of the platform and/or service may use to assert their identity to third parties. In some examples, an identity assertion provider may enable a user to authenticate to many services without having to complete a separate authentication process for each service. For example, a user may complete an authentication process to log in to an identity assertion provider and receive an authentication token that the user may use to authenticate to other applications, websites, and/or services that are third parties to the identity assertion provider. Examples of identity assertion providers may include, without limitation, GOOGLE+, FACEBOOK, and/or TWITTER.

In some embodiments, an identity assertion provider may not store user credentials for third-party applications. In one embodiment, an identity assertion provider may store credentials used to authenticate to the identity assertion provider but may not store any other credentials, in contrast to a credential store, which may store credentials for various applications that are third parties to the credential store.

In some embodiments, the identity assertion provider may provide authentication for and/or operate as a part of a social media platform. For example, a social media platform may use an authentication process to authenticate users to the social media platform. The provider of the social media platform may, additionally, provide an identity assertion service whereby users and/or applications may assert a user's identity using the same authentication process (e.g., the same credentials) used to authenticate to the social media platform. Thus, a user may authenticate to an application via the identity assertion provider using credentials for the social media platform (instead of, e.g., creating separate credentials for authenticating to the application). Additionally or alternatively, a user may connect an application to the social media platform by providing the user's credentials for the social media platform to the identity assertion service via the application (e.g., the application may access the identity assertion service via an application programming interface (API) to the identity assertion service).

The term “social media platform,” as used herein, generally refers to any website, platform, service, application, and/or combination thereof that enables users to create user accounts to connect with and/or exchange messages with other users. In some embodiments, a social media platform may enable users to post information about themselves on a personal page, post messages on other users' pages, privately message other users, create and/or join groups, and/or create and/or manage events. Examples of social media platforms may include, without limitation, FACEBOOK, LINKEDIN, and/or TWITTER.

The term “third-party application,” as used herein, generally refers to any application that is not part of the identity assertion provider (e.g., that is not owned by the identity assertion provider, that is not created by the identity assertion provider, that is not distributed by the identity assertion provider, that is not maintained by the identity assertion provider, and/or that does not natively share credentials and/or an authentication process with the identity assertion provider). In some examples, the term “third-party application” may refer to an application that accesses one or more services provided by the identity assertion provider only through one or more external APIs. For example, a mobile application version of the identity assertion provider may not be a third-party application, while a mobile application for a retailer may be a third-party application. In one example, a social medial platform such as FACEBOOK may be an identity assertion provider. In this example, a FACEBOOK mobile application may not be a third-party application while a NETFLIX mobile application may be a third-party application due to not being an instance of a FACEBOOK application. In some embodiments, the third-party application may include a mobile application designed for a mobile phone, tablet, smart watch, and/or other mobile device. In other embodiments, the third-party application may include a website designed to be viewed in an Internet browser application.

The identity assertion provider may identify the successful authentication in a variety of ways and/or contexts. For example, the identity assertion provider may identify the successful authentication by receiving a request from the third-party application for an authentication token from the identity assertion provider. In another example, the identity assertion provider may receive a request from a user for an authentication token to be issued to the third-party application.

In some examples, a user may provide the third-party application with an identifier associated with the user's account on the identity assertion provider, which may trigger the third-party application to request an authentication token from the identity assertion provider to enable the user to authenticate to the third-party application via the account with the identity assertion provider rather than requesting that the user create a new account for the third-party application. For example, a user may provide a website for a streaming service with the email address associated with the user's social media account, causing the streaming service to request an authentication token from the social media platform rather than prompting the user to create a new user account for use on the streaming service's website.

In some embodiments, the identity assertion provider may store the authentication token issued to the third-party application in connection with the user account for later use by the third-party application. In other embodiments, the identity assertion provider may generate new authentication tokens for each authentication attempt and/or each platform.

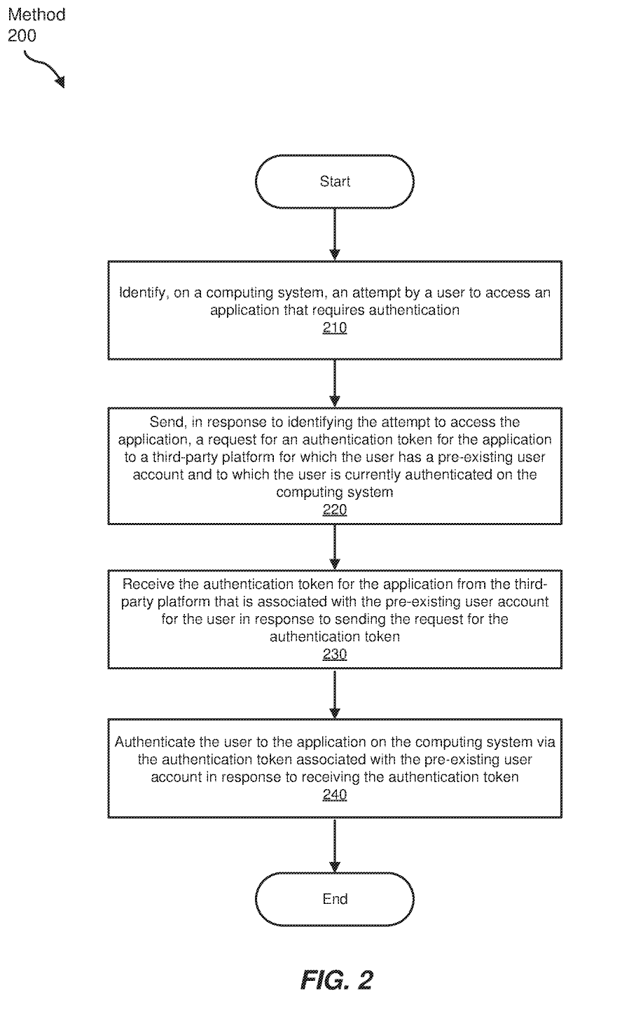

FIG. 2 is a flow diagram of exemplary method 200 for authenticating users. As illustrated in FIG. 2, at step 210, one or more of the systems described herein may identify, on a computing system, an attempt by a user to access an application that requires authentication.

The systems described herein may identify the attempt to access the application that requires authentication in a variety of ways and/or contexts. In one example, the systems described herein may identify the attempt by the user to access the application that requires authentication by identifying that the user is attempting to access an authenticated portion of the application that is separate from an unauthenticated portion of the application. For example, the application may include a public portion that does not require authentication and a private portion that is visible only to authenticated users, stores user specific-configurations, and/or enables authentication-protected functions such as messaging.

In some embodiments, the systems described herein may identify the attempt by the user to access the application that requires authentication by determining that the application accepts an authentication token provided by a third-party platform as a form of authentication. The term “third-party platform,” as used herein, generally refers to any platform that is a third party to the application to which the platform is providing an authentication token. In some embodiments, the third-party platform may be an identity assertion provider. In one embodiment, the systems described herein may reference a list of applications that accept the authentication token provided by the third-party platform. Additionally or alternatively, the application may indicate that the application accepts the authentication token provided by the third-party platform.

At step 220, one or more of the systems described herein may send, in response to identifying the attempt to access the application, a request for an authentication token for the application to a third-party platform for which the user has a pre-existing user account and to which the user is currently authenticated on the computing system.

The systems described herein may send the request for the authentication token in a variety of ways and/or contexts. In some embodiments, the systems described herein may determine that the user is currently authenticated to the third-party platform on the computing system before sending the request for the authentication token and/or may send the request for the authentication token in response to determining that the user is currently authenticated to the third-party platform. In one example, the systems described herein may prompt the user to authenticate to the third-party platform on the computing system.

Returning to FIG. 1, at step 120, one or more of the systems described herein may receive, by the identity assertion provider, a request from an additional computing system that does not include the computing system for an authentication token to authenticate the user to an instance of the third-party application on the additional computing system.

The identity assertion provider may receive the request from the additional computing system in a variety of contexts. In some examples, the additional computing system may be a computing system of a different type than the original computing system. For example, the original computing system on which the user authenticated to the application may be a desktop computer while the additional computing system may be a mobile device. In another example, the original computing system may be a mobile device with one type of operating system (e.g., an IPHONE) while the additional computing system may be a mobile device with a different type of operating system (e.g., an ANDROID phone). In some embodiments, the third-party application may include different instances on different computing systems. For example, an application may include a web instance designed to be displayed in an Internet browser as well as a mobile instance designed to be downloaded and executed by a mobile device that may both be accessible via the same user account.

In some embodiments, rather than attempting to authenticate via an additional computing system, a user may attempt to re-authenticate to the third-party application on the original computing system. For example, a user may have logged in to an application on a computing system, logged out of the application, and may later attempt to log in to the application again. In this example, the systems described herein may receive a request for an authentication token from the same instance of the application on the original computing system. Additionally or alternatively, the systems described herein may receive a request from a different instance of the application on the original computing system. For example, a user may authenticate to a mobile website version of an application via a mobile phone and may later download and attempt to authenticate to the mobile app version of the application on the same mobile phone.

At step 130, one or more of the systems described herein may determine that the user has previously authenticated to the third-party application on the computing system that does not include the additional computing system via the user account with the identity assertion provider.

The systems described herein may determine that the user has previously authenticated to the third-party application on the computing system in a variety of ways. In some embodiments, the identity assertion provider may store a record of each authentication made to a third-party application using an authentication token provided by the identity assertion provider. Additionally or alternatively, the identity assertion provider may associate a specific authentication token with each third-party application for each user account and may determine that the user has previously authenticated to the third-party application based on the existence of the authentication token associated with the third-party application and the user account of the user.

At step 140, one or more of the systems described herein may issue, to the instance of the third-party application on the additional computing system, an authentication token for the user of the third-party application that is associated with the user account for the identity assertion provider in response to determining that the user has previously authenticated to the third-party application via the user account.

The systems described herein may issue the authentication token in a variety of ways. In some embodiments, the identity assertion provider may issue an existing authentication token associated with the third-party application and the user account. In other embodiments, the identity assertion provider may generate a new authentication token and issue the new authentication token to the third-party application. In some embodiments, the identity assertion provider may issue the authentication token to the third-party application by sending the authentication token via a secure channel. For example, the identity assertion provider may send the authentication token via an encrypted protocol, such as hypertext transfer protocol secure (HTTPS).

Returning to FIG. 2, at step 230, one or more of the systems described herein may receive the authentication token for the application from the third-party platform that is associated with the pre-existing user account for the user in response to sending the request for the authentication token.

The systems described herein may receive the authentication token in a variety of ways. In some embodiments, the application may receive the authentication token via the same communication channel that the application used to request the authentication token. In other embodiments, the application may receive the authentication token via a different communication channel. In one embodiment, the application may receive the authentication token via a secure channel, such as HTTPS.

At step 240, one or more of the systems described herein may authenticate the user to the application on the computing system via the authentication token associated with the pre-existing user account in response to receiving the authentication token.

The systems described herein may authenticate the user to the application in a variety of ways. In some embodiments, the systems described herein may authenticate the user to the application on the computing system by notifying the user that the user has been authenticated to the application via the pre-existing user account. In one embodiment, the systems described herein may display a pop-up notification within the application notifying the user that the user has been automatically authenticated to the application. For example, as illustrated in FIG. 3, the systems described herein may authenticate the user to an application 304 on a mobile device 302. In some examples, the systems described herein may display a notification 308 that overlays a window for application 304 but is visually distinct from application content 306. In some embodiments, the systems described herein may draw notification 308 over the graphical user interface for application 304 and/or may instruct the operating system of the computing device to draw notification 308 over the interface for application 304. In one example, a notification may read, “Logged in as [the name of the user]” and/or include an icon representing the identity assertion provider.

In some embodiments, the systems described herein may present the user with an option to authenticate via the pre-existing user account with the identity assertion provider rather than automatically authenticating the user via the pre-existing user account. In one embodiment, the systems described herein may, when identifying the attempt to access the application, determine that the user has the pre-existing user account for the identity assertion provider and provide the user with an option to authenticate to the application via the pre-existing user account. In some examples, the systems described herein may determine that the user has chosen the option to authenticate to the application via the pre-existing user account and send the request for the authentication token in response to determining that the user has chosen the option to authenticate to the application via the pre-existing user account. For example, as illustrated in FIG. 4, the systems described herein may detect that the user is attempting to access an authenticated portion of an application 404 on a computing system 402. The systems described herein may present the user with the option to either authenticate to application 404 with credentials such as a username and/or password that are associated with a user account for application 404 or to be automatically authenticated to application 404 via the user's account with the identity assertion provider.

In some embodiments, the systems described herein may request an authentication token from the identity assertion provider in response to determining that the application accepts authentication tokens from the identity assertion provider and/or the user is currently authenticated to the identity assertion provider on the device that is executing the application. In other embodiments, the systems described herein may not request the authentication token until the user has indicated that the user wishes to authenticate via the user account with the identity assertion provider rather than authenticating via some other means or choosing not to authenticate.

In some examples, the systems described herein may authenticate the user to the application on the computing system via the authentication token by enabling the user to avoid authenticating to the application via an authentication step that requires user input. For example, the systems described herein may enable the user to skip the step of entering a username, password, security question answer, and/or cryptographic code. In some embodiments, the systems described herein may automatically authenticate the user to the application without the user performing any manual authentication steps.

In some embodiments, the systems described herein may receive the authentication token for the application from the third-party platform while also receiving a set of permissions for the application associated with the user account. In these embodiments, authenticating the user to the application on the computing system may include applying the set of permissions to the application. For example, a user may have given an application permission to access their location, microphone, and/or other sensor data. In some examples, a user may have agreed to an application's terms of service. Additionally or alternatively, a user may have given the application permissions regarding access to the user's information on the identity assertion provider. For example, a user may have given the application access to the user's profile information on the identity assertion provider. In some examples, a user may have given the application permission to perform functions on the identity assertion provider on behalf of the user. For example, a user may give an application permission to share links to the application on the identity assertion provider as if the links were posted by the user.

Additionally or alternatively, determining that the user has previously authenticated to the third-party application on the computing system may include determining that the user has previously applied a set of permissions to the third-party application on the computing system and issuing the authentication token to the instance of the third-party application on the additional computing system may include sending, to the additional computing system, the set of permissions for the third-party application that were previously applied by the user. In some embodiments, the identity assertion provider may store a set of permissions associated with each application and user account combination.

The systems described herein may be arranged in a variety of different configurations on devices of different types, in one embodiment, as illustrated in FIG. 5, an identity assertion provider 502 may communicate with a computing device 506 and/or a computing device 508 via a network 504. Network 504 may represent the Internet, one or more local networks, and/or a combination thereof. While illustrated as a single entity, identity assertion provider 502 may be hosted on multiple physical and/or virtual servers and/or computing devices in one or more locations. In some examples, an authentication identification module 512 on identity assertion provider 502 may identify a successful authentication by a user account 524 to an application 510 on computing device 508 via an authentication token provided by identity assertion provider 502.

At some later time, an application identification module 532 on computing device 506 may identify that the user is attempting to access application 510 on computing device 506. Next, a sending module 534 may send a request 520 to identity assertion provider 502 for an authentication token to authenticate the user to application 510 on computing device 506. A request receiving module 514 on identity assertion provider 502 may receive request 520. Next, a determining module 516 on identity assertion provider 502 may determine that the user has previously authenticated to application 510 and/or that the user has previously granted application 510 with a set of permissions 526. After making this determination, an issuing module 518 on identity assertion provider 502 may then issue a token 522 and/or permissions 526 to application 510 on computing device 506. In some embodiments, token 522 may be the same token used to authenticate the user to application 510 on computing device 508. In other embodiments, token 522 may be a new authentication token.

Next, a token receiving module 536 on computing device 506 may receive token 522 from identity assertion provider 502. Finally, an authentication module 538 may authenticate the user to application 510 on computing device 506 via token 522. In some embodiments, the systems described herein may display a notification to the user informing the user that the user has been authenticated to application 510 via user account 524 with identity assertion provider 502.

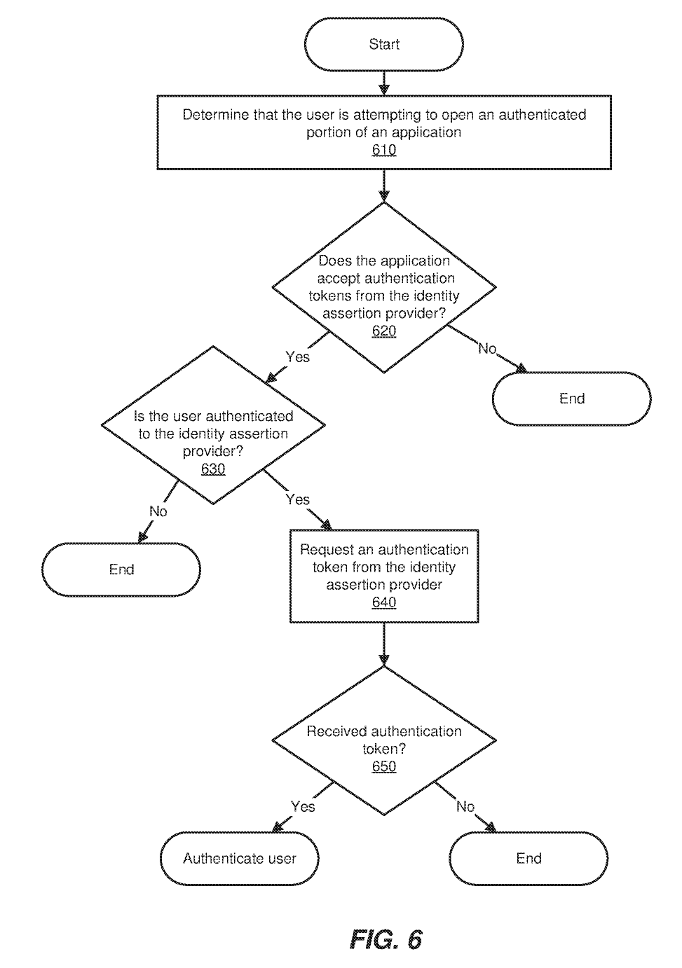

In some examples, the systems described herein may make a series of determinations before authenticating a user to an application. For example, as illustrated in FIG. 6, at step 610, the systems described herein may determine that a user is attempting to open an authenticated portion of the application. For example, the user may have opened a mobile application for a retailer that requires authentication to make purchases and/or post reviews. At decision 620, the systems described herein may determine whether the application accepts authentication tokens from an identity assertion provider, such as a social media platform, as a form of authentication. In some embodiments, the systems described herein may query the application to determine whether the application accepts the authentication token. Additionally or alternatively, the systems described herein may query the identity assertion provider. In some examples, if the application does not accept authentication tokens from the identity assertion provider, the process may end.

If the application does accept the authentication token, at decision 630 the systems described herein may determine whether the user is authenticated to the identity assertion provider on the device on which the user is attempting to authenticate to the application. In some examples, if the user is not authenticated to the identity assertion provider, the systems described herein may prompt the user to authenticate to the identity assertion provider. In some examples, if the user is not authenticated to the identity assertion provider, the process may end. If the user is authenticated to the identity assertion provider, at step 640 the systems described herein may request an authentication token from the identity assertion provider. In some examples, the identity assertion provider may then determine whether the user has previously authenticated to the application via a user account with the identity assertion provider before sending the authentication token. At decision 650, the systems described herein may determine whether the authentication token has been received from the identity assertion provider. If the systems described herein have received the authentication token, the systems described herein may authenticate the user to the application using the authentication token. If the systems described herein have not received the authentication token, the systems described herein may not authenticate the user to the application.

In some embodiments, the systems described herein may authenticate a user to an application using a user account with an identity assertion provider even if the user has not previously authenticated to the application via the user account. For example, a user may authenticate to an application using an email address. In some embodiments, the application may inform the identity assertion provider that the user has authenticated to the application using the email address. In some examples, the identity assertion provider may assign an identifier and/or authentication token to the user in conjunction with the email address and/or application. The user may later create an account with the identity assertion provider using the same email address. The systems described herein may then associate the user's account with the application with the user's account with the identity assertion provider based on the two accounts using the same email address. The next time the user accesses the application, the systems described herein may authenticate the user to the application via the user account with the identity assertion provider.

As explained above in connection with methods 100 and 200, the systems and methods described herein may enable users to automatically authenticate to applications on various platforms via an account with an identity assertion provider such as a social media platform. By authenticating a user via a pre-existing user account with an identity assertion provider, the systems and methods described herein may prevent the user from creating redundant duplicate accounts as well as presenting the user with a more efficient login process. Because the systems and methods described herein may only authenticate a user to an application if the user is already authenticated to the identity assertion provider, the systems and methods described herein may also increase the security of the user's accounts and systems by reducing the opportunities for fraudulent authentications to the user's accounts.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive application data to be transformed, transform the application data into information about existing authentication and/or permissions, output a result of the transformation to an authentication system, use the result of the transformation to authenticate and/or grant permissions to a user and/or application, and store the result of the transformation to compare against future authentication attempts. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying, on a computing system, an attempt by a user to access an application that requires authentication;
sending, in response to identifying the attempt to access the application, a request for an authentication token for the application to a third-party platform for which the user has a pre-existing user account and to which the user is currently authenticated on the computing system;
receiving the authentication token for the application from the third-party platform that is associated with the pre-existing user account for the user in response to sending the request for the authentication token; and
authenticating the user to the application on the computing system via the authentication token associated with the pre-existing user account in response to receiving the authentication token.

2. The computer-implemented method of claim 1, wherein authenticating the user to the application on the computing system comprises notifying the user that the user has been authenticated to the application via the pre-existing user account.

3. The computer-implemented method of claim 1, wherein:
identifying, on the computing system, the attempt by the user to access the application comprises:
determining that the user has the pre-existing user account for the third-party platform;
providing the user with an option to authenticate to the application via the pre-existing user account in response to determining that the user has the pre-existing user account; and
determining that the user has chosen the option to authenticate to the application via the pre-existing user account; and
sending the request for the authentication token for the application to the third-party platform is in response to determining that the user has chosen the option to authenticate to the application via the pre-existing user account.

4. The computer-implemented method of claim 1, wherein:
receiving the authentication token for the application from the third-party platform that is associated with the pre-existing user account comprises receiving a set of permissions for the application associated with the pre-existing user account; and
authenticating the user to the application on the computing system comprises applying the set of permissions to the application.

5. The computer-implemented method of claim 1, wherein identifying, on the computing system, the attempt by the user to access the application that requires authentication comprises identifying that the user is attempting to access an authenticated portion of the application that is separate from an unauthenticated portion of the application.

6. The computer-implemented method of claim 1, wherein identifying, on the computing system, the attempt by the user to access the application that requires authentication comprises determining that the application accepts the authentication token provided by the third-party platform as a form of authentication.

7. The computer-implemented method of claim 1, wherein authenticating the user to the application on the computing system via the authentication token comprises enabling the user to avoid authenticating to the application via an authentication step that requires user input.

8. The computer-implemented method of claim 1:
further comprising determining that the user is currently authenticated to the third-party platform on the computing system; and
wherein sending the request for an authentication token for the application to the third-party platform for which the user has the pre-existing user account and to which the user is currently authenticated on the computing system is in response to determining that the user is currently authenticated to the third-party platform on the computing system.

9. The computer-implemented method of claim 1, wherein the computing system comprises a mobile device.

10. The computer-implemented method of claim 1, wherein the third-party platform comprises a social media platform.

11. A computer-implemented method, at least a portion of the method being performed by a computing device comprising at least one processor, the method comprising:
identifying, by an identity assertion provider, a successful authentication by a user to a third-party application on a computing system via a user account of the user with the identity assertion provider;
receiving, by the identity assertion provider, a request from an additional computing system that does not comprise the computing system for an authentication token to authenticate the user to an instance of the third-party application on the additional computing system;
determining that the user has previously authenticated to the third-party application on the computing system that does not comprise the additional computing system via the user account with the identity assertion provider; and
issuing the authentication token to the instance of the third-party application on the additional computing system for the user of the third-party application that is associated with the user account for the identity assertion provider in response to determining that the user has previously authenticated to the third-party application via the user account.

12. The computer-implemented method of claim 11, wherein the identity assertion provider does not store user credentials for the third-party application.

13. The computer-implemented method of claim 11, wherein:
determining that the user has previously authenticated to the third-party application on the computing system comprises determining that the user previously authenticated to the third-party application on the computing system via the authentication token; and
issuing the authentication token to the instance of the third-party application on the additional computing system comprises issuing the same authentication token used for the third-party application on the computing system.

14. The computer-implemented method of claim 11, wherein:
determining that the user has previously authenticated to the third-party application on the computing system comprises determining that the user has previously applied a set of permissions to the third-party application on the computing system; and
issuing the authentication token to the instance of the third-party application on the additional computing system comprises sending, to the additional computing system, the set of permissions for the third-party application that were previously applied by the user.

15. The computer-implemented method of claim 11, wherein the identity assertion provider comprises a social networking platform.

16. The computer-implemented method of claim 11:
further comprising determining that the user is currently authenticated to the identity assertion provider via the additional computing system; and
wherein issuing the authentication token is in response to determining that the user is currently authenticated to the identity assertion provider via the additional computing system.

17. A system comprising:
an authentication identification module, stored in memory of an identity assertion provider, that identifies a successful authentication by a user to an application on a first computing system via a user account of the user with the identity assertion provider;
an application identification module, stored in memory of a second computing system, that identifies an attempt by the user to access the application that requires authentication;
a sending module, stored in the memory of the second computing system, that sends, in response to identifying the attempt by the user to access the application, a request for an authentication token for the application to the identity assertion provider for which the user has the user account and to which the user is currently authenticated on the second computing system;
a request receiving module, stored in the memory of the identity assertion provider, that receives the request from the second computing system that does not comprise the first computing system for the authentication token to authenticate the user to an instance of the application on the second computing system;
a determination module, stored in the memory of the identity assertion provider, that determines that the user has previously authenticated to the application on the first computing system that does not comprise the second computing system via the user account with the identity assertion provider;
an issuing module, stored in the memory of the identity assertion provider, that issues, to the instance of the application on the second computing system, the authentication token for the user of the application that is associated with the user account for the identity assertion provider in response to determining that the user has previously authenticated to the application via the user account;
a token receiving module, stored in the memory of the second computing system, that receives the authentication token for the application from the identity assertion provider that is associated with the user account in response to sending the request for the authentication token;
an authentication module, stored in the memory of the second computing system, that authenticates the user to the application on the second computing system via the authentication token associated with the user account in response to receiving the authentication token; and
at least one physical processor configured to execute the authentication identification module, the application identification module, the sending module, the request receiving module, the determination module, the issuing module, the token receiving module, and the authentication module.

18. The system of claim 17, wherein the authentication module authenticates the user to the application on the second computing system by notifying the user that the user has been authenticated to the application via the user account.

19. The system of claim 17, wherein:
the determination module determines that the user has previously authenticated to the application on the first computing system by determining that the user has previously applied a set of permissions to the application on the first computing system;
the issuing module issues, to the instance of the application on the second computing system, the authentication token by sending, to the second computing system, the set of permissions for the application that were previously applied by the user;
the token receiving module receives the authentication token for the application from the identity assertion provider that is associated with the user account by receiving the set of permissions for the application associated with the user account; and
the authentication module authenticates the user to the application on the second computing system by applying the set of permissions to the application.

20. The system of claim 17, wherein:
the identity assertion provider comprises a social networking platform that is a third party to the application;
the first computing system does not comprise a mobile device;
the second computing system comprises a mobile device; and
the instance of the application on the second computing system comprises a mobile application.
